(19) United States
(12) Patent Application Publication
(10) Pub. No.: US 2006/0007914 A1
(43) Pub. Date: Jan. 12, 2006

(54) Dynamic call parameter switchover and graceful degradation for optimizing VoIP performance in wireless local area networks

(76) Inventors: Praphul Chandra, Germantown, MD (US); David A. Lide, Rockville, MD (US); Satish Kumar Mundra, Germantown, MD (US); Manoj Sindhwani, Oak Hill, VA (US)

Correspondence Address: TEXAS INSTRUMENTS INCORPORATED, P O BOX 655474, M/S 3999, DALLAS, TX, 75265, US

(21) Appl. No.: 10/888,464

(22) Filed: Jul. 8, 2004

(51) Int. Cl. H04L 12/66; H04Q 7/24

(52) U.S. Cl. 370/352; 370/338; 370/229

(57) ABSTRACT

A system and method for transmitting voice data traffic over a wireless medium, such as a voice call using a wireless Internet Protocol mobile phone on a wireless local area network, to increase the quality and the number of voice calls on a Basic Service Set. Endpoints are capable of dynamically switching to alternate voice coding profiles. The WLAN is surveyed by a wireless endpoint to determine whether a congested network condition exists. Coding profiles may be dynamically switched to decrease the congested conditions and improve call quality. If dynamically switching of profiles in not available then the wireless endpoint gracefully degrades the transmission by periodically dropping packets until network congestion reduces and/or call quality increases.

### CROSS-REFERENCE TO RELATED APPLICATIONS

None

### FIELD OF THE INVENTION

The present invention relates generally to transmitting voice data over a wireless medium.

### BACKGROUND OF THE INVENTION

WLANs (Wireless Local Area Networks) utilize RF signals or light signals to connect mobile endpoints to each other or to a centralized gateway and transmit data over a wireless medium between the physical endpoints or between a mobile endpoint and an endpoint on a network that is connected to the WLAN. In 1997 the IEEE published standards for WLANs under the title of 802.11 (also known as “Wi-Fi”). The IEEE 802.11b protocol has gained popularity over the past few years and deployment of 802.11b networks is expected to increase significantly in the near future. Currently, most of these networks are used for data access from laptop computers and personal digital assistants (PDAs). Using a WLAN to place voice phone calls using VoIP (Voice over Internet Protocols) over WLAN is also expected to grow significantly in the near future. However, VoIP over WLAN presents a unique set of problems that must be addressed prior implementing this technology.

One of the most important problems in this area is the provision of adequate system capacity to support some significant number of VoIP connections per BSS (Basic Service Set). IEEE (Institute of Electrical and Electronic Engineers) 802.11 enables mobile stations (e.g., endpoints) to communicate through a wireless network interface directly with each other or with other stations (STAs) through an access point. An access point (AP) is a centralized gateway providing message and power management and access to an external Local Area Network (LAN) and/or the Internet.

There exists a plurality of 802.11 standards that each use different frequency bands and have varying data transmission speeds. The original IEEE 802.11 standard supported wireless interfaces operating at speeds of up to 2 megabyte per second (Mbps) in the 2.4 GHz radio band. By using different modulation techniques, IEEE 802.11b raised the data transmission rates to 11 Mbps, while 802.11a supports up to 54 Mbps transmission rates at a 5 GHz frequency. The IEEE 802.11g is developing standards for data transmission rates of 54 Mbps at the 2.4 GHz frequency.

WLANs under 802.11 use media access control (MAC) protocols to transmit between wired and wireless devices. Each wireless network card is assigned a MAC address used to identify the station. The basic protocol of an IEEE 802.11 network is the Basic Service Set (BSS), which is merely a number of endpoint stations that communicate with one another. The access to wireless networks is controlled by coordination functions. The distributed coordination function (DCF) provides an access mechanism (CSMA/CA) similar to the Ethernet access mechanism (CSMA/CD). The DCF determines if the RF link between devices is clear prior to transmitting. Stations use a random backoff after every frame to avoid collisions. Endpoint stations provide MAC Service Data Units (MSDUs) after detecting no current transmissions. The MSDUs functions to transmit data frames to the proper endpoint station.

Under the DCF access method of 802.11, each MSDU transmission incurs an overhead that includes a distributed interface space (DIFS) duration, a backoff interval, a Physical Layer Convergence Procedure (PLCP) preamble, a PLCP header, a MAC header, a SIFS duration, and an acknowledgment (ACK) time (which comprises a PLCP preamble, a PLCP header, and the ACK MPDU). Such an overhead amounts up to 764.2 μs on an 802.11b PHY with long PLCP preamble an 11 Mbps data rate, which can significantly decrease quality of data transmission.

FIG. 1 illustrates a schematic diagram of an exemplary WLAN enterprise network 10. Two wireless access points 12 and 14 are connected to an internal corporate Intranet 18. The Internet 20 may be accessed through intranet 18 or alternatively through APs 12, 14 after registering with a Radius authentication server 22. Each AP has a range of RF broadcast signals represented by area 24. Multiple APs 12 and 14 provide an enterprise wide footprint that can be accessed up to area 24, depending upon natural signal attenuation of a broadcast signal and interferences. An enterprise network typically has multiple APs distributed throughout an office or between multiple buildings so that the handset may be operated nearly anywhere in the network broadcast area 24. Since an 802.11 WLAN is traditionally a data network, a wireless endpoint such as laptop computer 16 may access the Internet 20.

The 802.11b MAC (Media Access Controller) is designed keeping in mind data traffic over the wireless medium. Since collisions are hard to detect, each packet is acknowledged (ACKed) by the receiver. Since the medium is shared, access to the medium is based on detecting the network idle (physically or logically) and on random back-off times. Since downstream traffic (from the AP to the laptops/PDAs) is usually much higher than the upstream traffic, 802.11b is inherently fair allowing each node equal access to the medium.

However, the above design decisions do not work well for VoIP over WLAN. First, the per-frame transmission overhead for 802.11b is very high. Besides the RTP (Real Time Protocol), UDP (User Data Protocol) and IP (Internet Protocol) headers which are inherent overheads in VoIP traffic, working with WLAN adds the high physical layer overhead which always gets transmitted at 1 Mbps. Besides the physical layer overhead, each data frame is also ACKed by the receiver. This adds another large overhead, increasing the size of each packet transmitted. Finally, the 802.11 MAC scheme of waiting for fixed (irrespective of payload size) collision avoidance sense timeouts (DIFS, SIFS) and random back-off times leads to another overhead increase in packet/frame size.

Given these overheads, it is not surprising that even though the maximum data rate that 802.11b currently supports is 11 Mbps, the theoretically maximum achievable throughput for 802.11b networks is much less. FIG. 2 illustrates a graph showing the theoretically maximum achievable throughput for 802.11b networks as a function of the payload size. Note that the throughput plotted in the graph is the net-throughput which is to be shared between all nodes in a BSS.

As FIG. 2 shows, the effective throughput has a large dependency on the payload size. Again, even though this is not an issue for data applications (since they large payload sizes), the payload and packet sizes can significantly affect voice data transmissions for real time applications like VoIP where the packet size needs to be kept short to minimized end-to-end delay. To summarize, since 802.11b has high overheads and since voice packets need to be small, VoIP has very limited throughput available for operation.

There is another aspect of the 802.11b which further restricts the available bandwidth for VoIP calls. This is the inherent fairness of the 802.11b protocol which does not discriminate between priority of nodes (e.g., endpoints) as far as access to the medium is concerned. This method is adequate when used for data traffic where the upstream traffic is much less than downstream traffic and the AP rarely has to compete with other nodes to access the wireless medium. However, for VoIP where traffic is bi-directionally balanced, each node is transmitting as much traffic as it is receiving (assuming no asymmetric codecs), and the voice data traffic has to traverse through the AP. This means that if there are N wireless IP phones in a BSS making calls to wired networks, the AP is handling N times the load as compared to any other node in the BSS. However, fairness in 802.11b would allow the AP to access the medium only as much as any other node. The result is that the AP will not be able to transmit the traffic that it is receiving. Since voice calls over a WLAN require real time traffic, a voice data packet which gets delayed beyond a limit waiting in the AP queue is rendered useless.

From the 802.11b MAC perspective, this situation arises because 802.11b requires that every station that finishes a transmission and has a packet waiting in its queue to perform a random back-off. In the build up to a congested network, the AP will almost always have more than one packet in its queue so it will be backing off, adding to its effective packet transmission time. IP phones placing calls on an 802.11 WLAN however, in most cases, will rarely have more than one packet to transmit unless network congestion is heavy or there are PHY (Physical) layer problems (such as moving out of range of the AP).

Thus, four of the major reasons for limited VoIP call capacity in a BSS are 1) large header transmission overhead, 2) ACK for each packet, 3) fixed values of Contention Window and DIFS for each station and frame, and 4) equal access priority for all stations in a BSS. Both 802.11e and WME in their current state of technology offer solutions for some these problems For example, WME allows ACKs to be optional and allows the AP to announce arbitrary Contention Windows and ‘DIFS’ sizes while using different values itself. These features of WME will allow VoIP implementations to solve the issues of ACKs, fixed values of Contention Windows and DIFS for each station and frame, and equal access priority. However the present invention can enhance performance irrespective of whether or not 802.11e/WME is in use.

### SUMMARY OF THE INVENTION

The limitations of the prior art are overcome by the present invention's system and method for transmitting voice data traffic over a wireless medium, such as placing a voice call using an IP phone on a WLAN, to increase the quality of calls and the number of voice calls on a BSS. A first aspect of the present invention includes establishing a voice call between a first endpoint and a second endpoint where at least the first endpoint is connected to a wireless local area network(WLAN). Voice data is transmitted from the first endpoint, over the WLAN, to the second endpoint using a coding profile. The WLAN is then surveyed to determine whether a congested network condition exists. If the congested network condition exists and the first and the second endpoints will transmit using an alternate coding profile, then the coding profile for the voice data transmissions may be dynamically switched to an alternate coding profile.

Another aspect of the claimed method includes establishing a voice over Internet Protocol (VOIP) call between the first endpoint and the second endpoint, where the dynamically switching includes the first endpoint dynamically switching the VOIP call to the alternative coding profile after determining a suitable VOIP coding profile that reduces the congested network condition from a plurality of alternative VOIP coding profiles. The WLAN of the preferred embodiment may be an IEEE 802.11 wireless network.

A further aspect of the dynamically switching to the alternative coding profile includes dynamically switching to an alternative coding profile that reduces an end-to-end delay for the call that is caused by the congested network condition. Still a further aspect of the dynamically switching of coding profiles includes dynamically switching to an alternative coding profile that formats larger packet sizes in the voice data transmission if the congested network condition increases and dynamically switching to an alternative coding profile that formats smaller packet sizes in the voice data transmission if the congested network condition decreases.

A further aspect of the claimed method further includes that if the congested network condition exists and the first endpoint or the second endpoint will not transmit the voice data using an alternate coding profile or if the congested network condition exists and said dynamically switching the coding profile will not reduce said congested network condition, then the quality of said voice data transmissions gracefully degrades. The graceful degradation includes the first endpoint periodically dropping voice data packets within the voice data transmission.

### BRIEF DESCRIPTION OF THE DRAWINGS

Preferred embodiments of the invention are discussed hereinafter in reference to the drawings, in which:

FIG. 1 illustrates an enterprise wireless local area network;

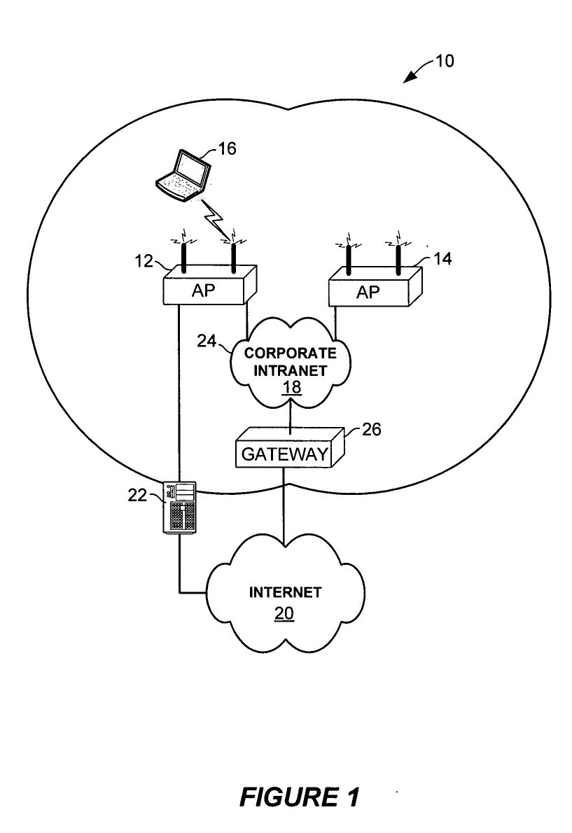

FIG. 2 illustrates a graph showing throughput versus bytes per data unit in an IEEE 802.11 wireless local area network;

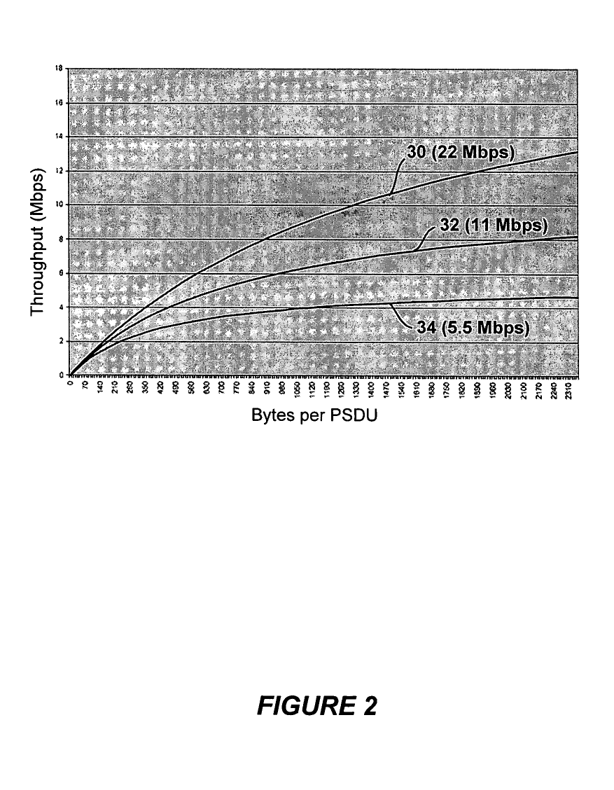

FIG. 3 illustrates an enterprise wireless local area network with voice over Internet protocol;

FIG. 4 illustrates a flowchart of dynamic call parameter switchover and graceful degradation in a wireless local area network.

### DETAILED DESCRIPTION OF PREFERRED EMBODIMENTS

The preferred embodiment of the present invention includes a technique of using dynamic coding-profile switchover to adapt to WLAN (Wireless Local Area Network)conditions in order to dynamically vary the number of VOIP (Voice over Internet Protocol) connections that the BSS (Basic Service Set) can support. One implementation of the preferred embodiment is in a IEEE 802.11 wireless local area network (WLAN). The term coding-profile is used to include a combination of codec, voice activity detection, and the packetization period at which the codec is operating. For a VOIP call, data packets are transmitted using a codec and a designated packetization period. For example, a call using ITU G.711 protocol with a 10 msec packetization period means that every 10 milliseconds one or more packets of voice data is formed into a frame and transmitted using real time protocol (RTP). Therefore, “G.711 with 10 msec packetization period”, “G.711 with 40 msec packetization period” and “G.729 with 40 msec packetization period” are three separate coding profiles under using ITU standards for VOIP.

An 802.11 WLAN network is a highly dynamic environment because of the inherent dynamics of the wireless medium, low operating power of 802.11b, and operation in the 2.4 GHz range. Since the 802.11b operates at low power (to save power and increase battery lifetimes), a geographically smaller BSS with multiple APs (Access Points) leads to frequent handoffs and roaming scenarios. Further, since 802.11b networks operates in the unlicenced frequency range of 2.4 GHz, it is potentially open to interference from other devices (e.g., microwaves, cordless phones, Bluetooth WLANs). The two major 802.11 QoS (Quality of Service) standards include the WME and the 802.11e.

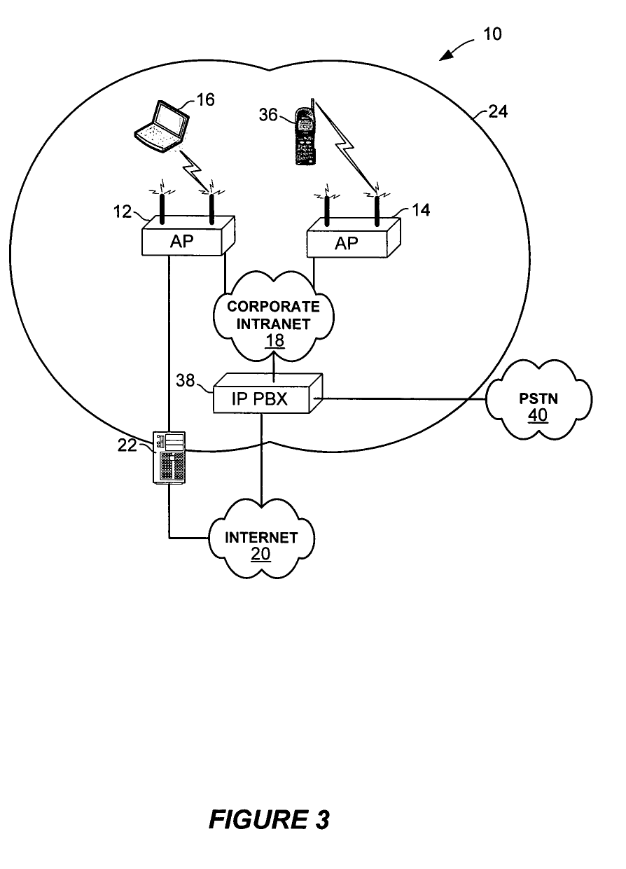

FIG. 3 illustrates a diagram of an exemplary enterprise WLAN network 10 that includes endpoint 36 (hereafter referred to as a WLAN IP Phone or WIPP 36) transmitting to AP 14 using VOIP. Enterprise network 10 is an IEEE 802.11 wireless local area network (WLAN) network typically employed by a large commercial office, industrial complex, or academic facility. WLAN 10 includes corporate intranet 18 that routes VOIP calls through an IP PBX (Personal Branch Exchange) 38 to the PSTN 40 (Publicly Switched Telephone Network) or over Internet 20. For implementing voice capability, a wireless LAN may use multiple access points and multiple access technologies (e.g., 802.11 a/g) to minimize interference and increase capacity and coverage. Depending upon the BSS implementation, WIPP 36 may “roam” between APs 12, 14 thereby allowing a user to move within the network coverage area 24 without dropping a call. While “roaming” is defined as the ability for a cellular phone customer to automatically make and receive calls when the cellular handset has geographically moved outside of a service provider's home network coverage area and use an alternate network operated by a different service provider, “roaming” between APs refers to a same concept to move WIPP 36 between different APs on the same or alternate networks. Enterprise-wide mobility allows affordable mobile connectivity to a large population of employees and can provide enterprise IP-PBX features on a mobile phone such as voice mail, conferencing, transfer, and extension dialing.

Most conventional VOIP implementations simply regard the WLAN network as an IP “cloud” without adequate information about the underlying link layer. However, in VOIP over WLAN, the characteristic of the underlying link layer in the “cloud” are known. Specifically, the number of VoIP calls that can exist in a BSS is a factor of the packetization period used. Once the information about the WLAN is known, the performance may be optimized.

It is known that the number of VOIP connections that can exist in a BSS increases with the use of larger packetization periods. However, higher payload sizes mean larger end-to-end delays in VOIP. Therefore a trade off exists between the end-to-end delay and system capacity. This trade off can be made during call setup.

When a WLAN signal is detected by the WIPP 36, the WIPP 36 transmits an association request to the transmitting AP 14, and the AP 14 responds back with an association response. Once the response is received, the WIPP 36 may enter an authentication process with the authentication server 22 or receive authentication through an authentication server located in intranet 18. As one skilled in the art will know, there are a number of possible authentication processes available for WLAN networks, such as 802.1x, Wi-Fi Protected Access (WPA) or static keys like WEP (Wired Equivalent Privacy). Wi-Fi Protected Access is a specification for a security enhances for data protection/encryption and access control/authentication for WLAN networks. The authentication server 22 is accessible through the AP 14. An example of an authentication process is the IETF's Extensible Authentication Protocol (EAP) for 802.1x. The authentication exchange is performed between WIPP 36 and the authentication server 22 through an authenticator. From the WIPP 36 to the authenticator, the protocol is defined as EAP over LANs (EAPOL) or EAP over wireless (EAPOW). On the back-end, the protocol used in RADIUS. The 802.1x authentication occurs after association, and an AP is the facilitator of the message exchange between an authentication server 22 and the WIPP 36.

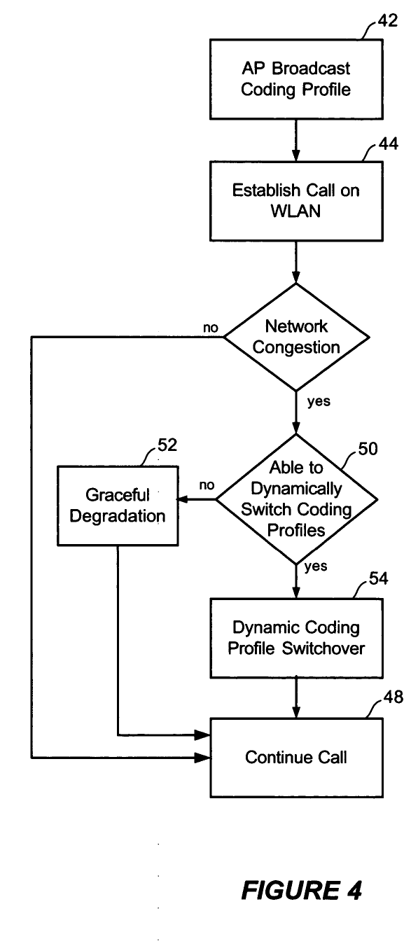

Referring to FIG. 4, after association, a VOIP call may be established 44 on the WLAN. The network is then surveyed to determine if network congestion is occurring 46. If no network congestion occurs, the call continues 48. If network congestion is detected, the WIPP 36 determines if both endpoints are able to dynamically switch coding profiles 50. If the coding profiles may be switched, the preferred embodiment dynamically changes the coding profile being used for the current call to a more suitable coding profile 50. For example, on a VOIP call that is established with the “G.711 with 20 ms packetization period” if during the call the BSS becomes congested or the WLAN endpoint making the VOIP call roams into a BSS which is highly congested, the coding profile is dynamically switched over 54 to a different profile and the call is continued 48. The more suitable coding profile for this case would be a profile with a larger packetization period.

This technique basically trades-off end-to-end delay in favor of allowing more VOIP over WLAN calls to exist in a congested BSS. If during the call the BSS load becomes reduced 56 or the WIPP roams into a BSS which is lightly loaded, the WIPP 36 may switch its coding profile again to a more suitable profile. The more suitable coding profile 54 for this case would be one with a smaller packetization period, which would reduce the end-to-end delay for the call.

If coding profiles cannot be dynamically switched, or if using even the most suitable coding profile does not reduce the load significantly in the BSS, the preferred embodiment uses graceful degradation 52 of voice quality. In an infrastructure WLAN network, an AP 12,14 is the first node to detect (e.g., suffer performance degradation from) network congestion. Thus, the AP 12,14 would be the first node to build up long transmission queues and begin dropping packets during a call.

Since AP 12,14 is dropping all packets that come after a certain point in time without any analysis, the packet loss pattern is random. When WIPP 36 determines that it is operating in a congested network even after it is using the most suitable coding profile, the WIPP 36 begins dropping packets periodically at regular intervals. With voice calls, periodic packet loss is more tolerable than packets being dropped in bursts. Bursty packet loss is likely to occur if the AP 14 is dropping the packets. This is avoided by having the WIPP 36 drop the packets itself periodically. The period, or frequency, with which packets are dropped are a factor of the level of congestion in the network.

The implementation of dynamic coding profile switchover requires that an endpoint track or know the congestion level of the BSS it is operating in. Next, this method requires that the communicating endpoints in a VOIP call be capable of dynamically changing coding profile without involving any form of signaling.

During the call set-up signaling 44, a list of coding profiles that the VoIP connection may use during the call is established. Mechanisms for implementing call set-up signaling, such as in the SDP (Session Description protocol) which is used by SIP and MGCP, may be used. SDP protocols can contain a list of coding profiles that can be used for the call without requiring any extra signaling beyond that required during call setup, i.e. the endpoints can use the coding profiles from profile list interchangeably during the call. Additionally, signaling capacity required for this also exists in H.245 which is used by H.323.

During call establishment 44, the WIPP 36 should advertise a list of N coding profiles that it wants to use during the call. After the call has been established, both VOIP endpoints are aware of the list of coding profiles that they may use dynamically during the call. Depending on the varying congestion level in the network, a WIPP may switch between using these coding profiles appropriately. For most implementations, this would simply involve switching to a large packetization period when the congestion level increases and switching to a lower packetization period when the congestion level decreases.

For example, assume a call that has been established between a WIPP and a wired WIPP with the default coding profile of “G.711 with 20 msec packetization period”. The WIPP decides to switch to a higher packetization period coding profile of “G.711 with 30 msec packetization period” since its BSS has become congested. When the wired IP phone detects that the voice stream coming from the WIPP has begun using a different coding profile, the wired IP phone must automatically switch both its decoding profile and its encoding profile to the new coding profile being received in the incoming voice stream. Switching its decoding profile to the new coding profile would allow the wired IP phone to decode the packets intelligibly and switching its encoding profile would reduce the load even further in the BSS. When the wired IP phone changes its encoding profile to the new coding profile, the WIPP would begin receiving voice packets with the new coding profile and would use this “signal” to switch its decoding profile. Therefore, a switch in encoding profile in one endpoint would successfully switch the coding profile being used (in both directions) for the call.

If the wired IP phone changes only a decoding profile and does not change an encoding profile, the call would still continue and the load in the BSS would have reduced too. However, the wired IP phone may switch its encoder leads to further reduce the BSS load.

The preferred embodiment is implemented with the assumptions that both the communicating endpoints in a VOIP over WLAN call are capable of dynamically changing codec without significant packet and frame loss. The AP 12 used for VOIP over WLAN calls may also be dedicated to VOIP. If the AP is not a dedicated VOIP AP, and if the WIPP controller uses the preferred embodiment, it may lead to placing it's VOIP transmission. WIPP controllers would take steps to curb the congestion by suffering increased delay, whereas data only nodes may not take any steps to reduce the load on the AP. A more effective WLAN could co-locate two APs (with enough frequency/channel-number separation) in the same geographical area and devote one AP to data applications and the other to VOIP applications. Finally, all WIPPs in a BSS should follow the preferred methods of dynamic codec switchover and graceful degradation because the preferred embodiment relies on cooperating WIPPs in a BSS. If a single WIPP, out of a plurality of conforming WIPPs, does not follow the dynamic codec switchover and graceful degradation, then non-conforming WIPP would receive higher “priority” of data transmission in terms of voice quality and cause the remaining WIPPS to suffer a degradation of service.

Further, if WIPP 36 is participating in a call place through the PSTN or an IP phone which is incapable of dynamically switching codec, a translator can be used in the path to implement the techniques of the present invention. The translator, which may be co-located in the AP, may be signaling-aware to establish a list of codecs with the WIPP and a single codec with the remote end. Then, during the call duration the translator would be responsible for translating the voice packets which travel through it.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A method for transmitting voice data traffic over a wireless medium, comprising:
establishing a voice call between a first endpoint and a second endpoint, wherein at least said first endpoint is connected to a wireless local area network(WLAN);
transmitting voice data from said first endpoint, over said WLAN, to said second endpoint using a coding profile;
determining whether a congested network condition exists on the WLAN;
determining whether the first endpoint and the second endpoint will transmit the voice data using an alternate coding profile; and
if the congested network condition exists and the first and the second endpoints will transmit using an alternate coding profile, dynamically switching said voice data transmission to said alternate coding profile.

2. The method of claim 1, wherein said establishing comprises establishing a voice over Internet Protocol (VOIP) call between the first endpoint and the second endpoint, and
said dynamically switching comprises the first endpoint dynamically switching said VOIP call to said alternate coding profile after determining that said alternate coding profile is a suitable VOIP coding profile that reduces the congested network condition.

3. The method of claim 1, wherein said WLAN is an Institute of Electrical and Electronic Engineers 802.11 wireless network.

4. The method of claim 1, wherein said dynamically switching to the alternative coding profile comprises dynamically switching to said alternative coding profile if said switching reduces an end-to-end delay for the call that is caused by the congested network condition.

5. The method of claim 1, wherein said dynamically switching comprises dynamically switching to said alternative coding profile that formats larger packet sizes in said voice data transmission if the congested network condition increases, and
dynamically switching to said alternative coding profile that formats smaller packet sizes in said voice data transmission if the congested network condition decreases.

6. The method of claim 1, wherein, if the congested network condition exists and the first endpoint and the second endpoint will not transmit the voice data using an alternate coding profile, gracefully degrading quality of said voice data transmissions.

7. The method of claim 1, wherein, if the congested network condition exists and said dynamically switching the coding profile will not reduce said congested network condition, gracefully degrading quality of said voice data transmissions.

8. The method of claim 6, wherein said gracefully degrading comprises said first endpoint periodically dropping voice data packets within said voice data transmission.

9. The method of claim 1, wherein said establishing comprises advertising, by the first endpoint, a list of N coding profiles that are possible for said first endpoint to use during said call.

10. The method of claim 1, wherein said establishing a voice call between said first endpoint and said second endpoint comprises establishing said voice call between a first wireless IP phone and a second wireless IP phone.

11. A method for dynamic call parameter switchover in a wireless network, comprising:
establishing a voice call over Internet Protocol using a first coding profile between a first wireless endpoint, connected to a wireless network, and a second endpoint;
determining if a congested network condition exists on the wireless network; and
if the congested network condition exists, and if transmitting said voice call using a second coding profile would reduce said congested network condition, then dynamically switching said voice call to said alternate coding profile.

12. The method of claim 11, wherein said establishing comprises transmitting voice data over Internet Protocol between a wireless IP phone and the second endpoint, and
said dynamically switching comprises negotiating between the wireless IP phone said second wireless endpoint to dynamically switch said first coding profile to one of a group of suitable coding profiles after said determining if a congested network condition exists on the wireless network.

13. The method of claim 11, wherein said WLAN is an Institute of Electrical and Electronic Engineers 802.11 wireless network.

14. The method of claim 11, wherein said dynamically switching to the second coding profile comprises dynamically switching to said second coding profile if said switching would reduce an end-to-end delay for the call that is caused by the congested network condition.

15. The method of claim 1, wherein said dynamically switching comprises dynamically switching to said second coding profile, wherein said second coding profile formats larger packet sizes in said voice call if the congested network condition increases, and
dynamically switching to said second coding, wherein said second profile formats smaller packet sizes in said voice call if the congested network condition decreases.

16. The method of claim 1, wherein, if the congested network condition exists and said dynamically switching the coding profile will not reduce said congested network condition, gracefully degrading quality of said voice data transmissions.

17. A system for transmitting voice data traffic over an Institute of Electronic and Electrical Engineers (IEEE) 802.11 wireless network connected to the Internet, comprises:
a first access point dedicated to data transmissions;
a second access point dedicated to voice over Internet Protocol (VOIP) transmissions;
a wireless Internet Protocol (IP) phone, wirelessly connected to said second access point, to establish a VOIP call with a remote phone through the Internet using a coding profile,
wherein, if a congested network condition exists on the wireless network during said VOIP call, the wireless IP phone and the remote phone dynamically switch to a new coding profile, selected from a group of suitable coding profiles, that will reduce the congested network condition.

18. Thy system of claim 17, wherein, if the congested network condition exists on the wireless network during the VOIP call, the wireless IP phone and the remote phone dynamically switch to a coding profile that will reduce said an end-to-end delay for the VOIP call that is caused by the congested network condition.

19. The system of claim 17, wherein if the congested network condition exists and the switch to a new coding profile will not reduce said congested network condition, then the wireless IP phone gracefully degrades quality of the VOIP call.
